(19) United States
(12) Patent Application Publication
(10) Pub. No.: US 2026/0307250 A1
(43) Pub. Date: Oct. 8, 2026

(54) APPARATUS AND METHOD FOR 3D SCENE GRAPH-BASED SPATIAL EXPLORATION FOR ROBOT

(71) Applicants: HYUNDAI MOTOR COMPANY, Seoul (KR); Kia Corporation, Seoul (KR)

(72) Inventors: Joohyung KIM, Hwaseong-si (KR); Jehong LEE, Hwaseong-si (KR); Sunwoo LEE, Hwaseong-si (KR); Yeongmin SONG, Hwaseong-si (KR)

(21) Appl. No.: 19/406,800

(22) Filed: Dec. 2, 2025

(30) Foreign Application Priority Data
Apr. 7, 2025 (KR) 10-2025-0044890

(51) Int. Cl. B25J 9/16; B25J 13/08; B25J 19/02

(52) U.S. Cl. CPC B25J 9/1664; B25J 9/161; B25J 9/1661; B25J 13/08; B25J 19/023

(57) ABSTRACT

A method and an apparatus for 3D scene graph-based spatial exploration for a robot. The method is performed by a computing device including a processor and a memory, and includes receiving user query data including a work request for the robot, identifying a location of the robot and generating a map based on sensor information collected by the robot, generating a 3D scene graph based on the identified location of the robot and the generated map, and inferring the exploration space for the robot to travel based on the user query data, the map, and the 3D scene graph.

### CROSS-REFERENCE TO RELATED APPLICATION

This application claims priority to and the benefit of Korean Patent Application No. 10-2025-0044890, filed with the Korean Intellectual Property Office on Apr. 7, 2025, the entire contents of which are incorporated herein by reference.

### TECHNICAL FIELD

The present disclosure relates to an apparatus and method for 3D scene graph-based spatial exploration for a robot, and more particularly, to an apparatus and method for 3D scene graph-based spatial exploration for a mobile manipulator robot to autonomously explore a space and perform a task.

### BACKGROUND

In the field of robotics, a method may be provided for exploring a space with a technology such as active mapping based on distance sensors.

For example, active mapping is a technique in which a robot or an autonomous system actively explores environments and builds maps. Unlike other passive mapping methods, active mapping may include exploration strategies that optimize information acquisition to enable efficient perception and understanding of unknown environments. In some cases, the mapping method may be inefficient due to the large amount of data and may have limitations in performing tasks corresponding to a human language.

In some cases, active mapping may be a method in which robots move toward locations with high uncertainty and expand exploration completion areas, and uncertainty-based exploration methods have limitations in directed task-oriented exploration.

### SUMMARY

The present disclosure describes a method for efficiently exploring a space by utilizing spatial semantic information.

For example, the present disclosure describes an apparatus and method for 3D scene graph-based spatial exploration for a robot capable of efficiently exploring a space by using a 3D scene graph which is in the form of semantic data in order for a mobile manipulation robot to perform a task in a space without a prior map.

The present disclosure further describes an apparatus and method for 3D scene graph-based spatial exploration for a robot capable of inferring an exploration space by using a graph attention network (GAT) based on a 3D scene graph.

According to one aspect of the subject matter described in this application, an apparatus for three-dimensional (3D) scene graph-based spatial exploration for a robot includes one or more processors and one or more memory devices storing a program code configured to, based on being executed by the one or more processors, cause the apparatus to perform operations. The operations include receiving user query data including a work request for the robot, identifying a location of the robot, generating a map based on sensor information collected by the robot, generating a 3D scene graph based on the location of the robot and the map, and inferring an exploration space for the robot to travel based on the user query data, the map, and the 3D scene graph.

Implementations according to this aspect can include one or more of the following features. For example, the operations can further include receiving and processing the sensor information, where processing the sensor information includes (i) extracting features from a plurality of images that are obtained at different times while the robot is travelling through the exploration space, and (ii) generating feature tracking information by matching the extracted features to one another and tracking the matched features.

In some implementations, generating the map can include generating an occupancy grid map as the map based on the feature tracking information, and based on the occupancy grid map, defining an area that is available for the robot to travel. In some implementations, generating the 3D scene graph can include defining a plurality of hierarchical nodes, where defining the plurality of hierarchical nodes can include defining an object node including object information about an object identified from the sensor information, defining agent nodes including path information defined along a traveling path of the robot, and defining one or more nodes of the agent nodes as place nodes based on an amount of the path information or an importance assigned to the agent nodes.

In some examples, the object information can include (i) three-dimensional pose information, (ii) spatial information comprising a size of a three-dimensional bounding box, (iii) an object class, and (iv) appearance information, where defining the object node can include converting the object information into a spatial feature or a visual feature through feature embedding, wherein the spatial feature or the visual feature has a form of a high-dimensional vector.

In some examples, inferring the exploration space can include, based on the map and the plurality of hierarchical nodes, defining exploration space candidate nodes from locations that are available for the robot to reach, extracting, from among the exploration space candidate nodes, a node having a highest probability of being reached by the robot based on an importance assigned to each of the exploration space candidate nodes, and selecting the extracted node as a next exploration space node.

In some examples, extracting the node having the highest probability of being reached by the robot can include determining the importance of each of the exploration space candidate nodes by using a graph attention network (GAT) based on the 3D scene graph and the user query data, and inferring the next exploration space based on the importance of each of the exploration space candidate nodes.

In some examples, inferring the exploration space based on the user query data, the map, and the 3D scene graph can include selecting, from among the exploration space candidate nodes, a node having a highest probability of completion of a task by the robot based on the user query data. In some examples, inferring the exploration space based on the user query data, the map, and the 3D scene graph can include defining a virtual query node by using an embedding feature of the user query data, and initializing a connectivity value between different nodes to a normalized value.

In some examples, inferring the exploration space based on the user query data, the map, and the 3D scene graph can include based on the spatial information being absent the user query data, initializing the spatial feature to a default value and using the visual feature as a feature obtained by processing the user query data.

According to another aspect, a method for three-dimensional (3D) scene graph-based spatial exploration for a robot is performed by a computing device comprising a processor and a memory. The method includes receiving, by the processor, user query data including a work request for the robot, identifying, by the processor, a location of the robot, generating, by the processor, a map based on sensor information collected by the robot, generating, by the processor, a 3D scene graph based on the location of the robot and the map, and inferring, by the processor, an exploration space for the robot to travel based on the user query data, the map, and the 3D scene graph.

Implementations according to this aspect can include one or more of the following features. For example, the method can include receiving and processing the sensor information, where processing the sensor information can include extracting features from a plurality of images that are obtained at different times while the robot is travelling through the exploration space, and generating feature tracking information by matching the extracted features to one another and tracking the matched features.

In some implementations, generating the map can include generating an occupancy grid map as the map based on the feature tracking information, and based on the occupancy grid map, defining an area that is available for the robot to travel.

In some implementations, generating the 3D scene graph can include defining a plurality of hierarchical nodes, where defining the plurality of hierarchical nodes can include defining an object node including object information about an object identified from the sensor information, defining agent nodes including path information defined along a traveling path of the robot, and defining one or more nodes of the agent nodes as place nodes based on an amount of the path information or an importance assigned to the agent nodes.

In some examples, the object information can include (i) three-dimensional pose information, (ii) spatial information comprising a size of a three-dimensional bounding box, (iii) an object class, and (iv) appearance information, where defining the object node can include converting the object information into a spatial feature or a visual feature through feature embedding, wherein the spatial feature or the visual feature has a form of a high-dimensional vector.

In some examples, inferring the exploration space can include, based on the map and the plurality of hierarchical nodes, defining exploration space candidate nodes from locations that are available for the robot to reach, extracting, from among the exploration space candidate nodes, a node having a highest probability of being reached by the robot based on an importance assigned to each of the exploration space candidate nodes, and selecting the extracted node as a next exploration space node.

In some examples, extracting the node having the highest probability of being reached by the robot can include determining the importance of each of the exploration space candidate nodes by using a graph attention network (GAT) based on the 3D scene graph and the user query data, and inferring the next exploration space based on the importance of each of the exploration space candidate nodes.

In some examples, inferring the exploration space based on the user query data, the map, and the 3D scene graph can include selecting, from among the exploration space candidate nodes, a node having a highest probability of completion of a task by the robot based on the user query data.

In some examples, inferring the exploration space based on the user query data, the map, and the 3D scene graph can include defining a virtual query node by using an embedding feature of the user query data, and initializing a connectivity value between different nodes to a normalized value.

In some examples, inferring the exploration space based on the user query data, the map, and the 3D scene graph can include based on the spatial information being absent from the user query data, initializing the spatial feature to a default value and using the visual feature as a feature obtained by processing the user query data.

In some implementations, the apparatus and method for 3D scene graph-based spatial exploration can efficiently explore a space by using the 3D scene graph including semantic information such that the mobile manipulation robot can complete a task in a first viewed space.

In some examples, the apparatus and method for 3D scene graph-based spatial exploration can store and utilize only the 3D scene graph without having to store the entire map information, and thus the explored spatial information can be compressively stored, thereby maximizing memory efficiency and easily responding to an environmental change.

### BRIEF DESCRIPTION OF THE DRAWINGS

FIG. 1 is a block diagram illustrating an example of an apparatus for 3D scene graph-based spatial exploration for a robot.

FIG. 2 is a flowchart of an example of a method for 3D scene graph-based spatial exploration for a robot.

FIG. 3 is a flowchart of an example of a method for processing user query data.

FIG. 4 is a diagram for describing an example of a sensor information processing module.

FIG. 5 is a diagram for describing an example of a memory processing module.

FIG. 6 is a diagram for describing an example of an exploration space inference and path planning module.

FIG. 7 is a flowchart of an example of a method for 3D scene graph-based spatial exploration for a robot.

FIG. 8 is a diagram illustrating an example of a method for 3D scene graph-based spatial exploration for a robot.

FIG. 9 is a diagram illustrating an example of a computing device.

### DETAILED DESCRIPTION

The present disclosure will be described more fully hereinafter with reference to the accompanying drawings, so that those skilled in the art to which the present disclosure pertains can easily implement the implementations of the present disclosure. However, the present disclosure can be implemented in many different forms and is not limited to the implementations described herein. In order to clearly explain the disclosure in the drawings, parts irrelevant to the description are omitted, and like reference numerals designate like elements throughout the specification.

In addition, at least some components or functions of the apparatus and method for 3D scene graph-based spatial exploration for the robot can be implemented in a program or software, and the program or software can be stored in a computer-readable medium.

Hereinafter, the implementations of the present disclosure are explained with reference to the drawings.

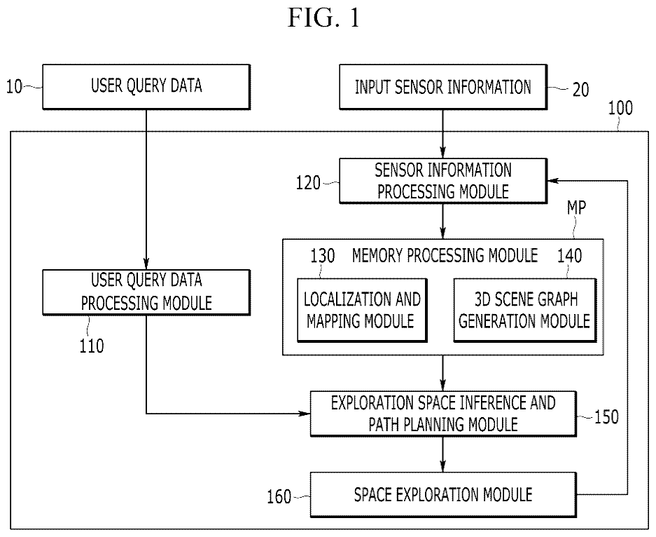

FIG. 1 is a block diagram illustrating an example of an apparatus for 3D scene graph-based spatial exploration for a robot.

In some implementations, an apparatus 100 for 3D scene graph-based spatial exploration for the robot can execute a program code or an instruction stored in one or more memory devices through one or more processors.

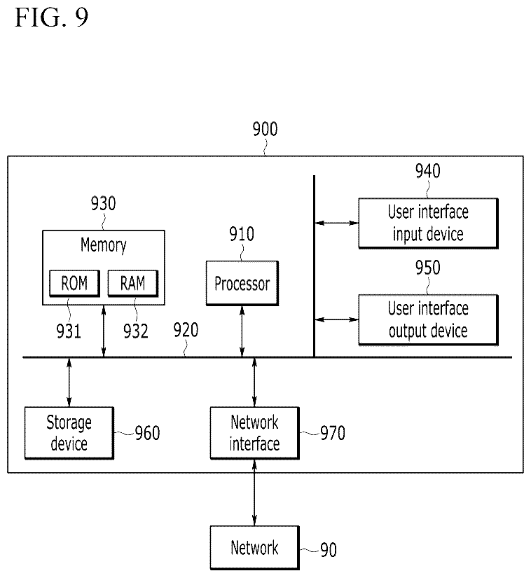

For example, the apparatus 100 for 3D scene graph-based spatial exploration for the robot can be implemented with a computing device 900 as described below in connection with FIG. 9. In some examples, one or more processors can be or include a processor 910 of the computing device 900, and one or more memory devices can be or include a memory 930 of the computing device 900.

The program code or the instruction can be executed by one or more processors to build a 3D scene graph and infer a space to explore such that the robot autonomously explores the space.

For example, when a user instructs the robot, such as a mobile manipulator robot, to perform a specific task, the apparatus 100 for 3D scene graph-based spatial exploration for the robot can infer an exploration space and generate a path plan such that the robot can autonomously explore the space to perform the specific task. In some implementations, the robot may refer to a mobile machine configured to move in a space and perform tasks according to user instructions.

Here, the term “module” was used to logically distinguish functions performed by program codes or instructions.

Referring to FIG. 1, the apparatus 100 for 3D scene graph-based spatial exploration for the robot can include a user query data processing module 110, a sensor information processing module 120, a localization and mapping module 130, a 3D scene graph generation module 140, an exploration space inference and path planning module 150, and a space exploration module 160.

The apparatus 100 for 3D scene graph-based spatial exploration for the robot can use task request data (e.g., user query data 10) of the user and input sensor information 20 received from a sensor of the robot as input.

The user query data processing module 110 can receive and process the user query data 10 including a work request for the robot.

The user query data processing module 110 can process the user query data 10 (e.g., text, audio, image, etc.) in the form of data that can be understood by the robot.

The user query data processing module 110 can provide the processed user query data to the exploration space inference and path planning module 150.

The sensor information processing module 120 can receive and process the input sensor information 20.

The sensor information processing module 120 can process the input sensor information 20 (e.g., image, depth, point cloud, IMU, GPS, etc.) in the form of data that can be understood by the robot and provide the processed form of data to a memory processing module MP as input.

The memory processing module MP can include the localization and mapping module 130 and the 3D scene graph generation module 140.

The memory processing module MP performs localization and mapping for the robot, and based on this, performs memory processing to build the 3D scene graph. The processed memory is in the form of map data that can be understood by the robot, and is used for exploration space inference and path planning.

The localization and mapping module 130 can identify a location of the robot and generate a map based on sensor information collected by the robot.

The 3D scene graph generation module 140 can generate the 3D scene graph based on the identified location of the robot and the generated map.

The 3D scene graph can include a data structure that hierarchically expresses relationships and structural information between objects in a 3D space.

That is, the 3D scene graph is not merely 3D point cloud or grid-shaped data but can have a hierarchical structure including relationships and meaning between objects.

The 3D scene graph is generally expressed as a graph structure, and can include nodes, edges, 3D locations, and geometric information.

Nodes include various information such as scenes, objects, attributes, etc., edges include relationship information between nodes, and 3D locations and geometric information include locations and shape information within a 3D space of objects.

The exploration space inference and path planning module 150 can infer the exploration space for the robot to move on based on the user query data, the map, and the 3D scene graph.

In some cases, the space exploration module 160 can continuously explore the next space based on the inferred exploration space and path plan, continuously process the input sensor information 20 entering in real time, and repeat the above process until the requested task is completed.

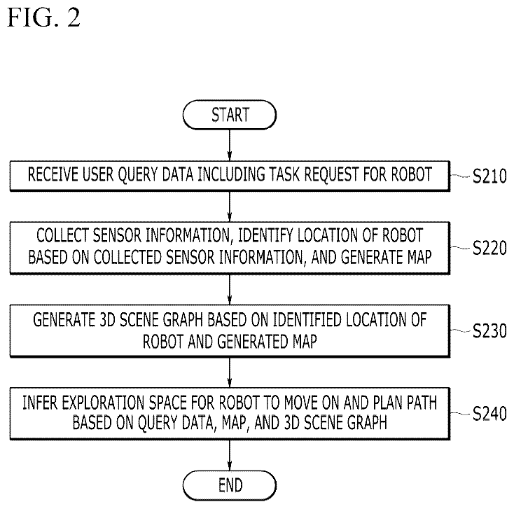

FIG. 2 is a flowchart of an example of a method for 3D scene graph-based spatial exploration for a robot. The method for 3D scene graph-based spatial exploration can be performed through the apparatus 100 for 3D scene graph-based spatial exploration (see FIG. 1).

In FIG. 2, the apparatus 100 for 3D scene graph-based spatial exploration for the robot can receive user query data including a task request for the robot (step S210).

The apparatus 100 for 3D scene graph-based spatial exploration for the robot can collect sensor information, identify the location of the robot based on the collected sensor information, and generate a map (step S220).

The apparatus 100 for 3D scene graph-based spatial exploration for the robot can generate a 3D scene graph based on the identified location of the robot and the generated map (step S230).

The apparatus 100 for 3D scene graph-based spatial exploration for the robot can infer an exploration space for the robot to move on and plan a path based on the query data, the map, and the 3D scene graph (step S240).

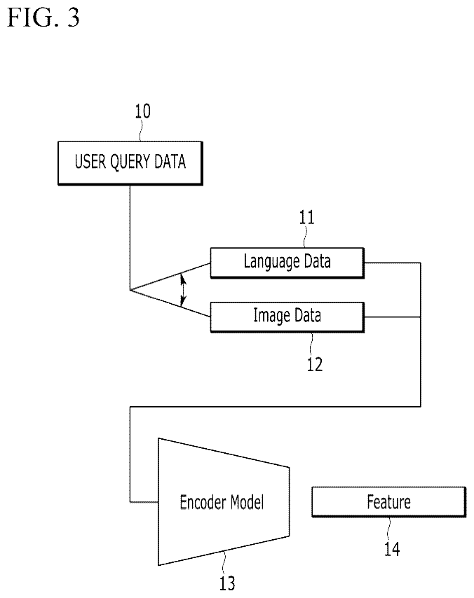

FIG. 3 is a flowchart of an example of a method for processing user query data. The method for processing user query data of FIG. 3 can be performed through the apparatus 100 for 3D scene graph-based spatial exploration for a robot or the user query data processing module 110 of FIG. 1.

In FIG. 3, the user query data 10 can be in the form of language data 11, image data 12, etc.

In some examples, a resulting feature 14 can be in the form of a high-dimensional vector.

The apparatus 100 for 3D scene graph-based spatial exploration for the robot can represent the user query data 10 in the form of feature embedding or optionally one-hot encoding by using an encoder model 13.

The apparatus 100 for 3D scene graph-based spatial exploration for the robot can use the feature vector 14 as an input in a subsequent exploration space inference step.

When the user query data 10 is given in the form of human language data 11, the apparatus 100 for 3D scene graph-based spatial exploration for the robot can convert it into the form of text data and calculate the result in the form of the feature 14 through a language mode.

When the user query data 10 is given in the form of the image data 12, the apparatus 100 for 3D scene graph-based spatial exploration for the robot can generate feature embedding by using a vision model.

Feature embedding is a technique that converts high-dimensional data into a low-dimensional continuous vector space (embedding space). Feature embedding is used in various fields such as natural language processing, recommendation systems, graph data analysis, etc.

Feature embedding can include graph embedding.

Graph embedding is a technique that transforms relationships between nodes or edges into vectors. For example, the graph embedding technique can include Node2Vec, DeepWalk, GraphSAGE, or a Graph Attention Network (GAT).

In addition, in the case of a system that a user can select from among predefined task instructions, the apparatus 100 for 3D scene graph-based spatial exploration for the robot can output an output in the form of a feature made in advance according to the selected task.

In this regard, the apparatus 100 for 3D scene graph-based spatial exploration for the robot can learn a language model and the vision model in advance by using techniques such as constructive learning and triplet loss.

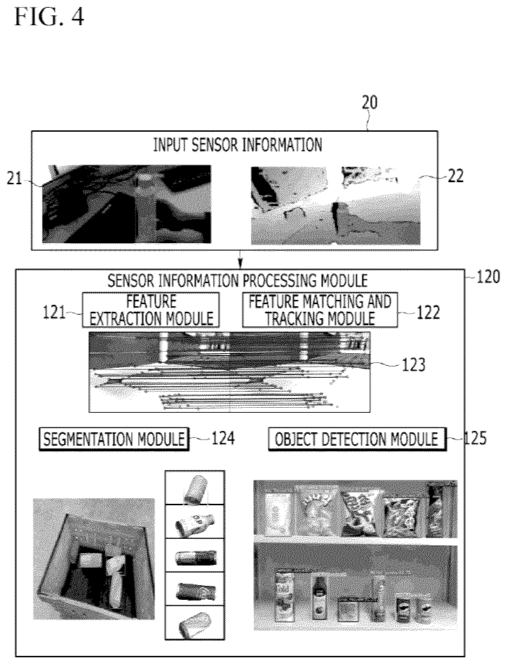

FIG. 4 is a diagram for describing an example of the sensor information processing module 120 (see FIG. 1).

In FIG. 4, a sensor includes one or more cameras, and the input sensor information 20 obtained therefrom can be in various forms.

For example, the input sensor information 20 can include RGB data, which is color information, and input data in the form of depth information.

The sensor information processing module 120 can include a feature extraction module 121 and a feature matching and tracking module 122.

The feature extraction module 121 can extract a feature with respect to each of a plurality of images obtained at different times while the robot is moving.

The feature matching and tracking module 122 can match the extracted features to each other and track the matched features to generate feature tracking information.

In some examples, feature tracking can be a process of continuously tracking the same feature point in a continuous image (video).

For instance, the feature matching and tracking module 122 can continuously track feature points in a video or image sequence to analyze a movement of an object, a movement of a camera, or a change in an environment.

The generated feature tracking information can include a feature point trajectory visually showing how specific key points move over time or optical flow vectors of each feature point.

In addition, the sensor information processing module 120 can include a segmentation module 124 and an object detection module 125.

The segmentation module 124 can perform semantic segmentation, instance segmentation, panoptic segmentation, etc.

The segmentation module 124 and/or the object detection module 125 can selectively utilize a segmentation result for feature matching and feature tracking to reduce a drift caused by a dynamic object.

The sensor information processing module 120 can transmit processed data to the memory processing module MP (see FIG. 1).

The processed sensor information can be used as input data of the localization and mapping module 130 (see FIG. 1) and the 3D scene graph generation module 140 (see FIG. 1).

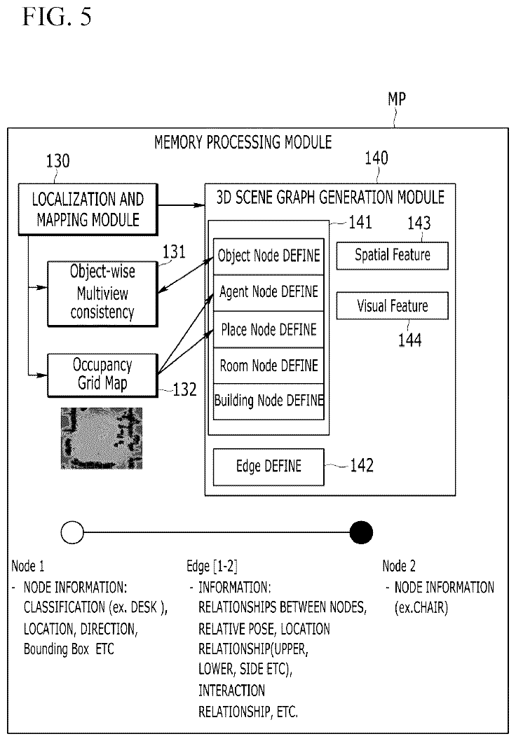

FIG. 5 is a diagram for describing an example of the memory processing module MP. FIG. 5 is a diagram illustrating a method for processing a memory by using sensor information processed in FIG. 4.

In FIG. 5, the localization and mapping module 130 can generate an occupancy grid map 132 based on feature tracking information and define an area that a robot is able to travel.

The occupancy grid map 132 and information about the area that the robot is able to travel can be stored in an agent node or a place node in a 3D scene graph and used later to define an exploration space candidate.

The 3D scene graph generation module 140 can generate the 3D scene graph based on the occupancy grid map 132 and location information of the robot

The 3D scene graph can include hierarchically defined nodes 141 and an edge 142.

The edge 142 can represent connectivity between the nodes 141 based on the location of the robot and information observed at the corresponding time by using an adjacent matrix.

The edge 142 can perform feature informatization and update through a graph neural network (GNN) or a graph attention network (GAT).

Alternatively, the edge 142 can define relationships between the nodes 141 based on a vision language model, etc.

The 3D scene graph generation module 140 can define the plurality of hierarchical nodes 141.

The 3D scene graph generation module 140 can define an object node including object information about an object identified from the sensor information.

The 3D scene graph generation module 140 can define an object node for each object identified in the step of processing the sensor information.

In this regard, the 3D scene graph generation module 140 can define one node for each object based on an object-wise multi-view consistency 131 observed at various times through the localization and mapping module 130.

The object information can include three-dimensional pose information (e.g., locations x, y, and z, and rotations roll, pitch, and yaw), spatial information including the size of a three-dimensional bounding box, an object class, and appearance information.

The 3D scene graph generation module 140 can convert the object information into a spatial feature 143 or a visual feature 144 that is in the form of a high-dimensional vector through feature embedding.

The spatial feature 143 can be generated through an embedding process with respect to two-dimensional or three-dimensional pose information of the object and information about the size of the three-dimensional bounding box.

The visual feature 144 can include the object class and the appearance information.

For example, the visual feature 144 can include a feature made by passing through an encoder once again with respect to a 2D bounding box image corresponding to the object after segmentation or object detection, or an output of an intermediate layer of a model used in segmentation and detection.

The 3D scene graph generation module 140 can define agent nodes including path information along a traveling path of the robot.

The 3D scene graph generation module 140 can define agent nodes along a path through which the robot actually moves or a path through which the robot can move based on the occupancy grid map 132.

The 3D scene graph generation module 140 can define some nodes of the agent nodes as place nodes based on the amount of path information or the importance of the agent nodes.

That is, the place node can include important nodes including a lot of information among agent nodes. For example, the place node can include an amount of information greater than a predetermined amount, where the importance can be determined based on comparing the amounts of information of the agent nodes.

The 3D scene graph generation module 140 can use feature embedding based on images and poses observed when defining the place node and a room node. The place node and the room node can be used to define an exploration space candidate later.

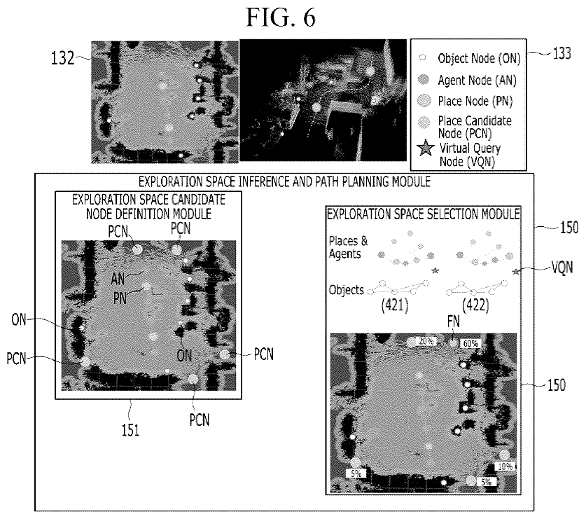

FIG. 6 is a diagram for describing an example of the exploration space inference and path planning module 150.

In FIG. 6, the exploration space inference and path planning module 150 can infer the next space for a robot to explore based on the occupancy grid map 132 and a 3D scene graph 133 generated in a memory processing step.

The exploration space inference and path planning module 150 can include an exploration space candidate node definition module 151 and an exploration space selection module 152.

The exploration space candidate node definition module 151 can define exploration space candidate nodes PCN with respect to locations that the robot is able to reach based on the map 132 and hierarchical nodes.

The exploration space selection module 152 can extract a node having the highest probability of reaching among the exploration space candidate nodes PCN based on the importance of each of the exploration space candidate nodes PCN, and select the extracted node as a next exploration space node FN.

The exploration space selection module 152 can determine the importance of the exploration space candidate nodes PCN by using a GAT or a GNN based on the 3D scene graph 133 and user query data, and infer a next exploration space based on the importance.

In some implementations, the exploration space inference and path planning module 150 can define a virtual query node VQN by utilizing an embedding feature of the user query data and initialize a connectivity value between different nodes to a normalized value.

In this regard, the exploration space inference and path planning module 150 can initialize a spatial feature to a default value when spatial information is not included in the user query data, and use a visual feature as a feature obtained by processing the user query data.

Thereafter, the exploration space inference and path planning module 150 can update features and edge information of nodes through the GAT based on a spatial feature and a visual feature vector embedded for each node.

In this regard, the exploration space inference and path planning module 150 can repeatedly perform intra-attention between the same hierarchical nodes and inter-attention between different hierarchical nodes.

The GAT, which is one of deep learning models that process graph data, is a GNN model that utilizes self-attention (self-attention mechanism) to enable each node to further focus on important neighboring nodes.

The GAT learns graph data like the existing graph convolutional network (GCN), but does not treat the importance of all neighboring nodes equally and gives higher weights to important nodes.

Intra-attention (self-attention) is mechanism to find related parts within the same input and adjust weights.

Inter-attention (cross-attention) can be mechanism to find relationships between different sets of inputs and adjust information.

The exploration space inference and path planning module 150 can calculate the importance of agent nodes AN through a regression model and update nodes with high importance to place nodes PN.

The exploration space inference and path planning module 150 can predict the importance of exploration space candidate nodes PCN through the regression model, and select a node with the highest probability from among the exploration space candidate nodes PCN as the next exploration space node FN.

Thereafter, the exploration space inference and path planning module 150 can plan a path for moving to the next exploration node based on the occupancy grid map 132.

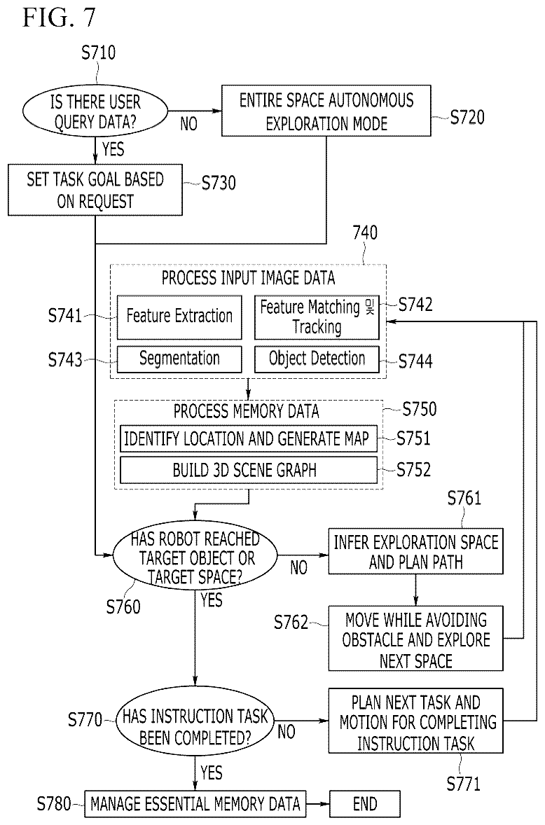

FIG. 7 is a flowchart of an example of a method for 3D scene graph-based spatial exploration for a robot.

The method for 3D scene graph-based spatial exploration for the robot of FIG. 7 can be performed through the apparatus 100 for 3D scene graph-based spatial exploration for the robot of FIG. 1.

FIG. 7 is a flowchart illustrating the method for 3D scene graph-based spatial exploration for the robot performed through the apparatus 100 for 3D scene graph-based spatial exploration for the robot when the robot is instructed to perform exploration in an unknown space or a known space.

In FIG. 7, the apparatus 100 for 3D scene graph-based spatial exploration for the robot determines whether user query data has been received (step S710).

When the user query data is not received, the apparatus 100 for 3D scene graph-based spatial exploration for the robot autonomously explores the entire space (step S720).

When the user query data is received, the apparatus 100 for 3D scene graph-based spatial exploration for the robot can set a task goal based on a task request of a user (step S730)

The apparatus 100 for 3D scene graph-based spatial exploration for the robot can receive and process sensor information including input image data (step S740)

The apparatus 100 for 3D scene graph-based spatial exploration for the robot can extract a feature with respect to each of a plurality of images obtained by the robot at different times while moving (step S741).

The apparatus 100 for 3D scene graph-based spatial exploration for the robot can match the extracted features to each other and track the matched features to generate feature tracking information (step S742).

For example, the apparatus 100 for 3D scene graph-based spatial exploration for the robot can allow a mobile manipulator robot to explore a space and process input image data from a camera among various sensors in the robot.

In this regard, the apparatus 100 for 3D scene graph-based spatial exploration for the robot can selectively perform feature extraction, feature matching, tracking, segmentation (step S743), and object detection (step S744).

The apparatus 100 for 3D scene graph-based spatial exploration for the robot can generate an occupancy grid map as a map based on feature tracking information and define an area that the robot is able to travel.

That is, the apparatus 100 for 3D scene graph-based spatial exploration for the robot can identify the location of the robot (step S751) in the memory data processing step (step S750) by using the processed data, and can generate a 3D scene graph (step S752).

The apparatus 100 for 3D scene graph-based spatial exploration for the robot can define a plurality of hierarchical nodes and an edge when generating the 3D scene graph.

The apparatus 100 for 3D scene graph-based spatial exploration for the robot can define an object node including object information about an object identified from the sensor information.

The apparatus 100 for 3D scene graph-based spatial exploration for the robot can convert the object information into spatial features or visual features that are high-dimensional vectors through feature embedding.

The apparatus 100 for 3D scene graph-based spatial exploration for the robot can define an agent node including path information along a traveling path of the robot.

The apparatus 100 for 3D scene graph-based spatial exploration for the robot can define some nodes among agent nodes as place nodes based on the amount of path information or the importance of the agent node.

The apparatus 100 for 3D scene graph-based spatial exploration for the robot can determine whether the robot moves and reaches a target object or a target space corresponding to the detailed task goal (step S760).

When it is determined that the robot has not yet reached, the apparatus 100 for 3D scene graph-based spatial exploration for the robot can infer the next exploration space and plan a path (step S761).

When inferring the next exploration space, the apparatus 100 for 3D scene graph-based spatial exploration for the robot can move while avoiding an obstacle in real time and continue to perform the next exploration space (step S762).

In this regard, the apparatus 100 for 3D scene graph-based spatial exploration for the robot can generate a candidate for the next exploration space based on the 3D scene graph and the occupancy grid map, infer a space candidate with the highest probability of completing the task, and plan a path.

That is, the apparatus 100 for 3D scene graph-based spatial exploration for the robot defines exploration space candidate nodes with respect to locations that the robot can reach based on a map and the hierarchical nodes.

The apparatus 100 for 3D scene graph-based spatial exploration for the robot can extract a node with the highest probability of reaching from among the exploration space candidate nodes based on the importance of each of the exploration space candidate nodes, and select the extracted node as the next exploration space node.

The apparatus 100 for 3D scene graph-based spatial exploration for the robot can determine the importance of exploration space candidate nodes by using a deep learning network that processes graph data such as a GAT or a GNN based on the 3D scene graph and the user query data and infer the next exploration space based on the importance.

When it is determined that the robot has reached the target object/space, the apparatus 100 for 3D scene graph-based spatial exploration for the robot determines whether the instruction task of the user has been completed (step S770).

When the task has not been completed, the apparatus 100 for 3D scene graph-based spatial exploration for the robot can process the next task and motion planning and perform the next detailed goal (step S771).

When the work has been completed, the apparatus 100 for 3D scene graph-based spatial exploration for the robot can erase unnecessary memory data (location and map data) and store only the 3D scene graph, which is memory data for performing a task in the same space later, and then end the process (step S780).

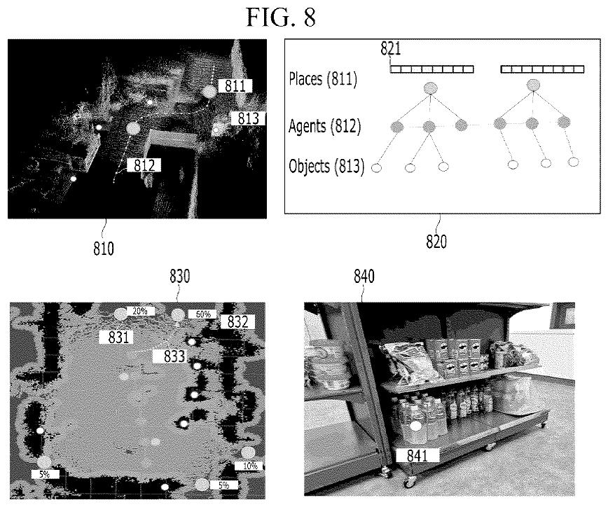

FIG. 8 is a diagram illustrating an example of a method for 3D scene graph-based spatial exploration for a robot.

The method for 3D scene graph-based spatial exploration for the robot of FIG. 8 can be performed through the apparatus 100 for 3D scene graph-based spatial exploration for the robot of FIG. 1.

In FIG. 8, a mobile manipulator robot can start traveling at the request of a user to bring a target object (e.g., an ion drink) within a first viewed space or to explore a target space.

The request of the user can be voice, text, or video.

The apparatus 100 for 3D scene graph-based spatial exploration for the robot can generate a map of the location and surrounding environment of the robot based on data obtained by a sensor of the robot while the mobile manipulator robot is traveling (810).

At the same time, the apparatus 100 for 3D scene graph-based spatial exploration for the robot can generate a 3D scene graph with connectivity of found places 811, traveling paths 812 of robot agents, a place node, an agent node, an object node, and an edge with respect to objects 813.

When generating the 3D scene graph, the apparatus 100 for 3D scene graph-based spatial exploration for the robot can use semantic information such as object detection, semantic segmentation, instance, or panoptic segmentation obtained through sensor information.

The apparatus 100 for 3D scene graph-based spatial exploration for the robot can generate a map 830 including an occupancy grid map and a 3D scene graph represented in the form of a hierarchical structure on the map 830.

The apparatus 100 for 3D scene graph-based spatial exploration for the robot can represent the 3D scene graph in the form 820 of buildings—rooms—places—agents & objects in the order of an upper layer to a lower layer.

The apparatus 100 for 3D scene graph-based spatial exploration for the robot can represent features of a place from feature information and connectivity information of nodes and edge by performing feature embedding 821 (visual feature and spatial feature). This can be understood as summarized information of features of the corresponding space.

The apparatus 100 for 3D scene graph-based spatial exploration for the robot can define candidates 831 with respect to spaces in which the robot can travel next from the occupancy grid map in the step of inferring the exploration space.

The apparatus 100 for 3D scene graph-based spatial exploration for the robot can infer a next exploration space 832 with the highest probability of completing a task among candidate spaces from feature embedding information of place and a graph structure and plan a path 833.

The apparatus 100 for 3D scene graph-based spatial exploration for the robot can infer the next exploration space by defining a probability of a candidate space through a GNN by using the 3D scene graph and user query data.

In some implementations, the apparatus 100 for 3D scene graph-based spatial exploration for the robot can input information about 3D scene graph spaces and an instruction task (query data) of a user by using prompt and a language model, and use the same to select the next exploration space.

The apparatus 100 for 3D scene graph-based spatial exploration for the robot can determine whether the instruction task has been completed when the robot explores a space and finds a target space 840 or a target object 841.

When the instruction task has been completed, the apparatus 100 for 3D scene graph-based spatial exploration for the robot stores memory data and then ends the process, and when an additional task is instructed, plans the next task and motion.

For example, when the robot is instructed to return with an ion drink, the robot can continue a task of picking up the ion drink with a manipulator and returning to a desired location based on the 3D scene graph in a memory.

FIG. 9 is a diagram illustrating an example of a computing device.

Referring to FIG. 9, in some implementations, an apparatus and method for 3D scene graph-based spatial exploration for a robot can be implemented by using the computing device 900.

The computing device 900 can include at least one of the processor 910, the memory 930, a user interface input device 940, a user interface output device 950, and a storage device 960 that communicate with each other over a bus 920. The computing device 900 can also include a network interface 970 that is electrically connected to a network 90. The network interface 970 can transmit or receive signals to and from other entities through the network 90.

The processor 910 can be implemented as a variety of types, such as a Micro Controller Unit (MCU), Application Processor (AP), Central Processing Unit (CPU), Graphic Processing Unit (GPU), and Neural Processing Unit (NPU), and can be any semiconductor device that executes commands stored in the memory 930 or the storage device 960. The processor 910 can be configured to implement the functions and methods described above with respect to FIGS. 1 to 8.

The memory 930 and the storage device 960 can include various types of volatile or non-volatile storage media. For example, the memory 930 can include read-only memory (ROM) 931 and random access memory (RAM) 932. In some implementations, the memory 930 can be located inside or outside the processor 910, and the memory 930 can be connected to the processor 910 through various known means.

In some implementations, at least some components or functions of the apparatus and method for 3D scene graph-based spatial exploration for the robot can be implemented in a program or software executed by the computing device 900, and the program or software can be stored in a computer-readable medium.

In some implementations, at least some components or functions of the apparatus and method for 3D scene graph-based spatial exploration for the robot can be implemented by using hardware or circuit of the computing device 900, or can be implemented as separate hardware or circuit that can be electrically connected to the computing device 900.

Although the implementations of the disclosure have been described in detail above, the scope of the disclosure is not limited thereto, and various modifications and improvements made by those of ordinary skill in the field to which the disclosure pertains also belong to the scope of the disclosure.

What is claimed is:

1. An apparatus for three-dimensional (3D) scene graph-based spatial exploration for a robot, the apparatus comprising:
one or more processors; and
one or more memory devices storing a program code configured to, based on being executed by the one or more processors, cause the apparatus to perform operations comprising:
receiving user query data including a work request for the robot,
identifying a location of the robot,
generating a map based on sensor information collected by the robot,
generating a 3D scene graph based on the location of the robot and the map, and
inferring an exploration space for the robot to travel based on the user query data, the map, and the 3D scene graph.

2. The apparatus of claim 1, wherein the operations further comprise receiving and processing the sensor information, and
wherein processing the sensor information comprises:
extracting features from a plurality of images that are obtained at different times while the robot is travelling through the exploration space,
generating feature tracking information by matching the extracted features to one another and tracking the matched features.

3. The apparatus of claim 2, wherein generating the map comprises:
generating an occupancy grid map as the map based on the feature tracking information; and
based on the occupancy grid map, defining an area that is available for the robot to travel.

4. The apparatus of claim 1, wherein generating the 3D scene graph comprises defining a plurality of hierarchical nodes, and
wherein defining the plurality of hierarchical nodes comprises:
defining an object node including object information about an object identified from the sensor information,
defining agent nodes including path information defined along a traveling path of the robot, and
defining one or more nodes of the agent nodes as place nodes based on an amount of the path information or an importance assigned to the agent nodes.

5. The apparatus of claim 4, wherein the object information comprises (i) three-dimensional pose information, (ii) spatial information comprising a size of a three-dimensional bounding box, (iii) an object class, and (iv) appearance information, and
wherein defining the object node comprises converting the object information into a spatial feature or a visual feature through feature embedding, wherein the spatial feature or the visual feature has a form of a high-dimensional vector.

6. The apparatus of claim 5, wherein inferring the exploration space comprises:
based on the map and the plurality of hierarchical nodes, defining exploration space candidate nodes from locations that are available for the robot to reach;
extracting, from among the exploration space candidate nodes, a node having a highest probability of being reached by the robot based on an importance assigned to each of the exploration space candidate nodes; and
selecting the extracted node as a next exploration space node.

7. The apparatus of claim 6, wherein extracting the node having the highest probability of being reached by the robot comprises:
determining the importance of each of the exploration space candidate nodes by using a graph attention network (GAT) based on the 3D scene graph and the user query data; and
inferring the next exploration space based on the importance of each of the exploration space candidate nodes.

8. The apparatus of claim 7, wherein inferring the exploration space based on the user query data, the map, and the 3D scene graph comprises:
selecting, from among the exploration space candidate nodes, a node having a highest probability of completion of a task by the robot based on the user query data.

9. The apparatus of claim 6, wherein inferring the exploration space based on the user query data, the map, and the 3D scene graph comprises:
defining a virtual query node by using an embedding feature of the user query data; and
initializing a connectivity value between different nodes to a normalized value.

10. The apparatus of claim 9, wherein inferring the exploration space based on the user query data, the map, and the 3D scene graph comprises:
based on the spatial information being absent the user query data, initializing the spatial feature to a default value and using the visual feature as a feature obtained by processing the user query data.

11. A method for three-dimensional (3D) scene graph-based spatial exploration for a robot, the method being performed by a computing device comprising a processor and a memory, the method comprising:
receiving, by the processor, user query data including a work request for the robot;
identifying, by the processor, a location of the robot;
generating, by the processor, a map based on sensor information collected by the robot;
generating, by the processor, a 3D scene graph based on the location of the robot and the map; and
inferring, by the processor, an exploration space for the robot to travel based on the user query data, the map, and the 3D scene graph.

12. The method of claim 11, further comprising receiving and processing the sensor information,
wherein processing the sensor information comprises:
extracting features from a plurality of images that are obtained at different times while the robot is travelling through the exploration space; and
generating feature tracking information by matching the extracted features to one another and tracking the matched features.

13. The method of claim 12, wherein generating the map comprises:
generating an occupancy grid map as the map based on the feature tracking information; and
based on the occupancy grid map, defining an area that is available for the robot to travel.

14. The method of claim 11, wherein generating the 3D scene graph comprises defining a plurality of hierarchical nodes, and
wherein defining the plurality of hierarchical nodes comprises:
defining an object node including object information about an object identified from the sensor information,
defining agent nodes including path information defined along a traveling path of the robot, and
defining one or more nodes of the agent nodes as place nodes based on an amount of the path information or an importance assigned to the agent nodes.

15. The method of claim 14, wherein the object information comprises (i) three-dimensional pose information, (ii) spatial information comprising a size of a three-dimensional bounding box, (iii) an object class, and (iv) appearance information, and
wherein defining the object node comprises converting the object information into a spatial feature or a visual feature through feature embedding, wherein the spatial feature or the visual feature has a form of a high-dimensional vector.

16. The method of claim 15, wherein inferring the exploration space comprises:
based on the map and the plurality of hierarchical nodes, defining exploration space candidate nodes from locations that are available for the robot to reach;
extracting, from among the exploration space candidate nodes, a node having a highest probability of being reached by the robot based on an importance assigned to each of the exploration space candidate nodes; and
selecting the extracted node as a next exploration space node.

17. The method of claim 16, wherein extracting the node having the highest probability of being reached by the robot comprises:
determining the importance of each of the exploration space candidate nodes by using a graph attention network (GAT) based on the 3D scene graph and the user query data; and
inferring the next exploration space based on the importance of each of the exploration space candidate nodes.

18. The method of claim 17, wherein inferring the exploration space based on the user query data, the map, and the 3D scene graph comprises:
selecting, from among the exploration space candidate nodes, a node having a highest probability of completion of a task by the robot based on the user query data.

19. The method of claim 16, wherein inferring the exploration space based on the user query data, the map, and the 3D scene graph comprises:
defining a virtual query node by using an embedding feature of the user query data; and
initializing a connectivity value between different nodes to a normalized value.

20. The method of claim 19, wherein inferring the exploration space based on the user query data, the map, and the 3D scene graph comprises:
based on the spatial information being absent from the user query data, initializing the spatial feature to a default value and using the visual feature as a feature obtained by processing the user query data.
